(19) United States
(12) Patent Application Publication
(10) Pub. No.: US 2023/0332792 A1
(43) Pub. Date: Oct. 19, 2023

(54) AUTOMATED BYPASS CONTROLLER FOR HEATING, VENTILATION, AND COOLING SYSTEMS

(71) Applicant: Block Logix Technologies LLC, Redmond, WA (US)

(72) Inventors: Ronald Ellis Chapman, Prineville, OR (US); Kenneth Scott Wade, Johannesburg, MI (US); Michael Paul Dunn, Redmond, WA (US)

(73) Assignee: Block Logix Technologies LLC, Redmond, WA (US)

(21) Appl. No.: 17/719,542

(22) Filed: Apr. 13, 2022

(51) Int. Cl. F24F 11/63; G05B 19/042; F24F 11/72

(52) U.S. Cl. CPC F24F 11/63; F24F 11/72; G05B 19/042; G05B 2219/2614

(57) ABSTRACT

Embodiments described herein provide methods, techniques, and apparatuses for controlling HVAC ventilation using a bypass mechanism called the Economizer Bypass Controller (“EBC”). The EBC is designed to be installed into any HVAC system, regardless of the economizer capabilities. The EBC provides “bypass functionality” as needed between an economizer and a damper mechanism to control outside air ventilation regardless of what the actual economizer is set up to do. Thus, the EBC can be used to meet ASHRAE (American Society of Heating, Refrigerating and Air-Conditioning Engineers) safety standards as they evolve, OSHA, and CDC guidelines as well as temporary or permanent health emergency bypass strategies such as to address increased or decreased ventilation needs due to, for example, pandemic emergencies or smokey conditions from wildfires. The EBC can also implement bypass strategies to address other communications/control situations such as a vacation settings, remote controlled overrides, or in response to alarm conditions.

### CROSS-REFERENCE TO RELATED APPLICATIONS

This application claims the benefit of U.S. Provisional Pat. Application No. 63/174,528, entitled “AUTOMATED BYPASS CONTROLLER FOR HEATING, VENTILATION, AND COOLING SYSTEMS,” filed Apr. 13, 2021, which application is incorporated herein by reference in its entirety.

### TECHNICAL FIELD

The present disclosure relates to methods, techniques, apparatuses and systems for controlling roof mounted ventilation systems and, in particular, to methods, apparatuses techniques, and systems for automatically controlling economizers in rooftop HVAC appliances to control outside air intake.

### BACKGROUND

Existing heating, ventilation, and cooling (HVAC) systems are commonly installed on rooftops of buildings and control the input of outside air and the mixing of outside air with vented air from the building (return air flow) to deliver heated or cooled air to the building. Economizers, such as the Honeywell Jade™, Siemens POL220, and Johnson Controls PEAK™ economizers, reduce air conditioning costs by using free outside air (OA) for free cooling rather than mechanically air-conditioned air. Economizers simply cause the HVAC compressor to run less often. Economizers move the dampers (louvers that allow outside air to flow into the HVAC unit) towards maximum ventilation position when outside air conditions are favorable for cooling and towards minimum ventilation position when outside air conditions are not. Programming, environmental sensors, and mechanical connections must be installed properly and optimally for an economizer system to effectively save energy and money for a building.

### BRIEF DESCRIPTION OF THE DRAWINGS

FIG. 1 is an example block diagram of an existing rooftop HVAC unit.

FIG. 2 is an example block diagram of rooftop HVAC unit modified to include an Economizer Bypass Controller.

FIG. 3 is an example block diagram of components of an example Economizer Bypass Controller.

FIG. 4 is an example Economizer Bypass Controller board showing example inputs and outputs.

FIGS. 5A-5D is flow diagram of example bypass mode and override selection routine of an example Economizer Bypass Controller to provide bypass and override capabilities between an economizer and a damper actuator.

FIG. 6 is an example flow diagram of an increased ventilation mode routine of an example Economizer Bypass Controller using a temperature sensor to modulate increased damper ventilation.

FIG. 7 is an example flow diagram of an increased ventilation mode routine of an example Economizer Bypass Controller using a CO₂ sensor to modulate increased damper ventilation.

FIG. 8 is an example flow diagram of a passthrough pulse mode routine of an example Economizer Bypass Controller that provides increased ventilation for set cycles of time (pulsed increased ventilation).

FIG. 9 is an example flow diagram illustrating handling of floating controller economizer adaptation.

FIG. 10 an example block diagram of an example Economizer Bypass Controller as a computing system used to communicate in a networked environment.

### DETAILED DESCRIPTION

Existing HVAC Economizers are designed to minimize energy use. They are designed to use as much outside air as possible rather than mechanically processing a building’s recirculating air, whenever it makes economic sense to do so. Their automated nature, in conjunction with improvements in construction and the strong economic incentive to buy as little energy as possible, along with the moral imperative to do what’s right, has resulted in highly efficient buildings. However, these highly efficient buildings do not necessarily produce healthy building environments. For example, a phenomenon known as “sick building syndrome” has emerged in which building occupants experience acute health and comfort effects that appear to be linked to time spent in a building, but no specific illness or cause can be identified. In addition, HVAC economizers have no knowledge of emergency conditions and therefore cannot adapt to such. For example, they are unable to adapt to health emergency conditions such as to increase ventilation responsive to, for example, a COVID-19 pandemic where greater outside air is desirable or to decrease ventilation as responsive to, for example, smokey conditions of a wildfire wherein outside air is undesirable.

As well, a building that is too uncomfortably ventilated (either as too hot or too cold) is difficult to occupy. Increased ventilation accomplished by simply opening windows does not solve the aforementioned difficulties because it is economically impractical to heat or cool every building while windows are wide open. Moreover, existing installed HVAC systems aren’t necessarily equipped with sufficient “horsepower” to comfortably maintain temperatures with all of the windows open, even if it were economically feasible to do so.

Embodiments described herein provide methods, techniques, and apparatuses for controlling HVAC ventilation using a bypass mechanism called the Economizer Bypass Controller (“EBC”). A particular example implementation described herein is called the Econologix™ Economizer Bypass Controller. The EBC is designed to be installed into any HVAC (rooftop) system, regardless of the capabilities of the economizer. Thus, it may be installed in systems varying from simple to complex. The EBC provides “bypass functionality” as needed between an economizer and a damper mechanism to control the amount of outside air ventilation regardless of what the actual economizer is set up to do. Thus, the EBC can be used to meet ASHRAE (American Society of Heating, Refrigerating and Air-Conditioning Engineers) safety standards as they evolve, OSHA, and CDC guidelines as well as temporary or permanent health emergency bypass strategies such as to address increased or decreased ventilation needs due to, for example, pandemic emergencies or smokey conditions from wildfires. As well, the EBC can implement bypass strategies to address other communications or control such as a vacation setting capable of shutting down the system for some period of time, remote controlled overrides, or based upon detection of “alarm” conditions (a sensor sensing that some aspect of the HVAC unit is not working properly).

An EBC installation provides its own temperature and environmental sensors to enable the EBC to operate regardless of the capabilities and structure of the economizer. Therefore, the EBC can be effectively retrofitted into an existing HVAC rooftop unit as well as placed in a new HVAC installation. In addition, the EBC can be used with any kind of economizer including “dumb” economizers up to electronically smart controlled economizers. Moreover, the EBC is economizer agnostic and damper mechanism agnostic because it sits between the outputs of the economizer and generates inputs to the damper mechanism. It includes a variety of bypass modes, including the ability to simply pass through the existing economizer signal, and includes a variety of special override conditions, which can be used to override the bypass conditions as well as other override conditions depending upon how the modes and overrides are configured.

In an example EBC installation, there are at least two temperature sensors. One sensor is placed to sense the temperature of the air entering the mechanical cooling section of the HVAC unit to control the dampers to prevent the cooling coils from freezing. The second temperature sensor is placed to sense the temperature of the return air as a proxy measurement for the air temperature in the building (occupied spaces) to determine when to stop certain bypass modes (e.g., full open dampers) because the HVAC system cannot keep up with cooling/heating needs to regulate the occupied space temperature. Some bypass (and bypass override) modes take these temperatures into account, others do not.

Several types of environmental sensors may also be present in an EBC installation, including sensors for detecting and monitoring CO₂, CO, VOC, SO₂, and NO₂. Other sensors may also be similarly incorporated.

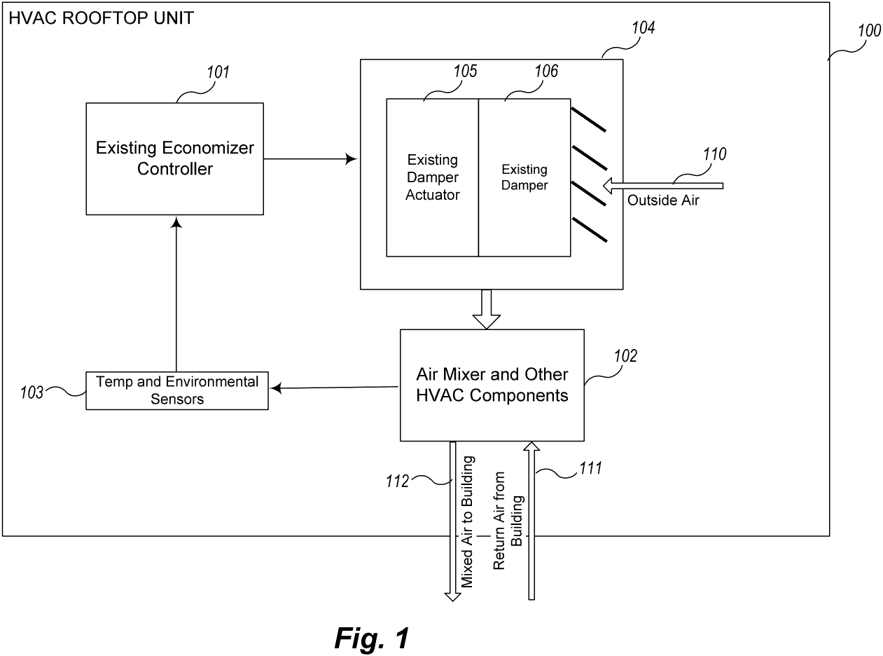

FIG. 1 is an example block diagram of an existing rooftop HVAC unit. HVAC roof top unit (RTU) 100 comprises an economizer controller 101 and damper unit 104 arranged in a feedback loop. Outside air 110 enters the damper unit 104 through damper louvers 106, which are controlled by a damper actuator 105. The economizer controller 101, based upon temperature and environmental sensor input 103, controls the opening and closing of damper louvers 106 by controlling the damper actuator 105. It’s a closed-loop system designed to meet some predefined goal; return air from the building 111 is mixed in the air mixer and other HVAC components 102 with some controlled amount of outside air 110, and the resultant mixed air 112 is sent back into the building. When the damper louvers 106 are fully shut, the indoor building air is recirculated. When the damper louvers 106 are fully open, cool air is mixed with building air to service the building.

In general operation, the RTU (or indoor air handler) 100 is notified by a thermostat to cool a building. If an economizer 101 is present, and the outside air 110 is better than recirculated indoor air for cooling the building, the outside air damper 104 will open to allow the outside air 110 to enter the building. This is referred to as “Free Cooling” because the condensing unit compressor in the HVAC unit 100 is not required to run (or at least not as often) to cool the space. Other than a fan or blower, no energy is consumed, and therefore minimal cost is incurred to cool the building. Anytime the conditions outdoors are better than indoors (cooler and/or drier), “Free Cooling” is available. Only when the outdoor temperature drops to 56° F. or lower and the indoor heat is removed do you get “True Free Cooling.” If the outside air temperature is not cool enough, or in some cases a high level of humidity is present, the economizer 101 will not open the damper louvers 106 and the cooling will have to be achieved mechanically (through the compressor).

An example economizer (for example, an existing Honeywell device) measures inside and outside air temperatures and other parameters and controls the dampers to maximize energy efficiency targeting the goal of “True Free Cooling.” Extensive programming, electrical wiring, and mechanical connections are employed to create an actual working economizer system. It is well recognized that outdoor air can be both healing or harmful depending on what is happening both outside and inside a building. The United States Environmental Protection Agency (EPA) and other advising bodies have issued advice for indoor air quality that advocates, in one case, minimizing fresh air intake into building and, in another case, maximizing fresh air intake during temporary emergency health conditions.

This advice is not contradictory. In the case of mitigating the risk of spreading airborne illnesses such as the COVID-19 virus, it is important to maximize fresh air intake to reduce potential airborne transmission of the virus. See for example, “https://www.epa.gov/coronavirus/indoor-air-and-coronavirus-covid-19”. In the case of wildfire smoke affecting indoor air quality, it is important to minimize fresh air intake “https://www.epa.gov/indoor-air-quality-iaq/wildfires-and-indoor-air-quality-iaq” to minimize smoke exposure to the building occupants.

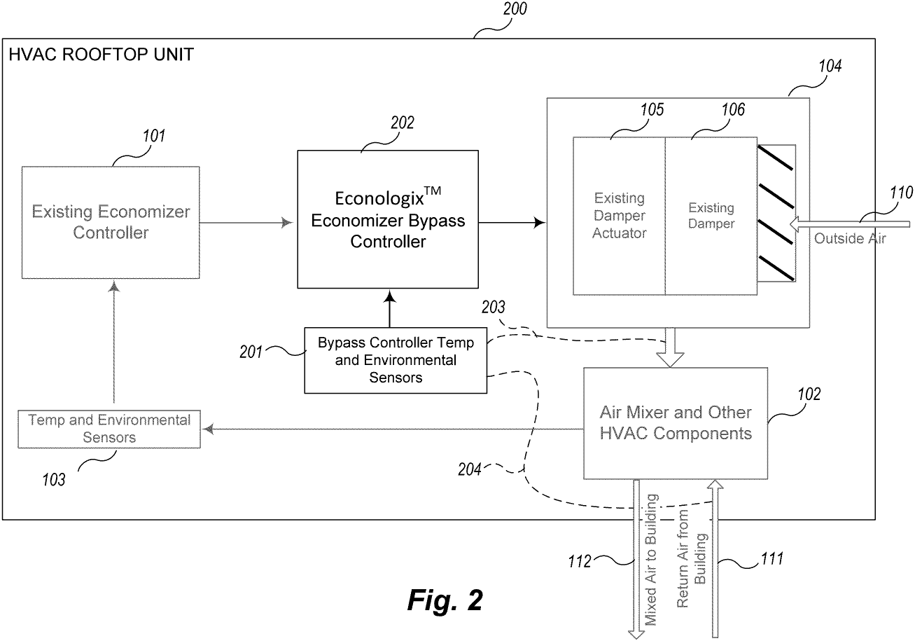

FIG. 2 is an example block diagram of rooftop HVAC unit modified to include an Economizer Bypass Controller. HVAC RTU 200 is shown with the existing closed feedback loop described with reference FIG. 1, including the existing economizer controller 101, temperature and environments sensors 103, damper unit 104, and air mixer and other HVAC components 102. HVAC RTU 200 is an improved HVAC unit modified to include the Economizer Bypass Controller 202 (the EBC). The EBC 202 is located between the economizer controller 101 and the damper unit 104. It is wired to intercept output signals from the economizer controller 101, perform bypass computations based upon them, and subsequently output signals to control the damper actuator 105 to either close, open, in full or in part, the damper louvers 106 to control the amount of outside air 110 intake. In this manner, the EBC 202 is able to “bypass” the effects of the economizer controller 101 when it is deemed appropriate to do so.

Adding an EBC 202 to the control circuit for controlling a damper unit 104 adds several features including the ability to bypass an economizer for health, wildfire, or other emergency reasons. For example, to address a COVID-19 emergency, the EBC 202 leverages an existing economizer’s energy savings strategy while overlaying a temporary health emergency bypass strategy to maximize outside air ventilation. Similarly, to address a wildfire emergency, the EBC 202 leverages the existing economizer’s energy savings strategy while overlaying a temporary health emergency bypass strategy to minimize outside air ventilation.

The EBC 202 also solves current issues that attempt to employ opening or closing windows to control air temperature. A building that is too uncomfortably ventilated (either as too hot or too cold) isn’t worth occupying. Nor does the world have enough money to heat or cool every building while the windows are wide open. Nor is there necessarily enough HVAC horsepower in an already installed system to comfortably maintain temperatures with all those windows open, even if one had the money.

Currently, in response to health emergencies, a typical protocol involves:
(1) Upon detection of an initial emergency condition:
   Reprogram economizer to emergency mode
   Modify electrical control wiring
   Modify mechanical connections
(2) Upon notification of an end of the emergency condition:
   Reprogram economizer to initial setting
   Un-Modify electrical control wiring
   Un-Modify mechanical connections
each time an emergency occurs.

Instead, the addition of an EBC 202 to the RTU 200, allows a revised protocol that involves:
(1) Upon detection of an initial emergency condition:
   Add EBC to control wiring
   Switch to EBC Bypass Mode
(2) Upon notification of an end of the emergency condition:
   Switch to EBC Passthrough Mode

Of note, once an EBC 202 is added to a roof top unit 200, it can be controlled using a variety of mechanisms including remotely, by a computer system connected via a network (wired or wirelessly), mechanically, through a remote control device, and the like. In “Bypass Mode” the damper unit 104 can be controlled by local manual adjustment by local programming. In “Passthrough Mode” the economizer controls the damper using its normal energy efficient strategy.

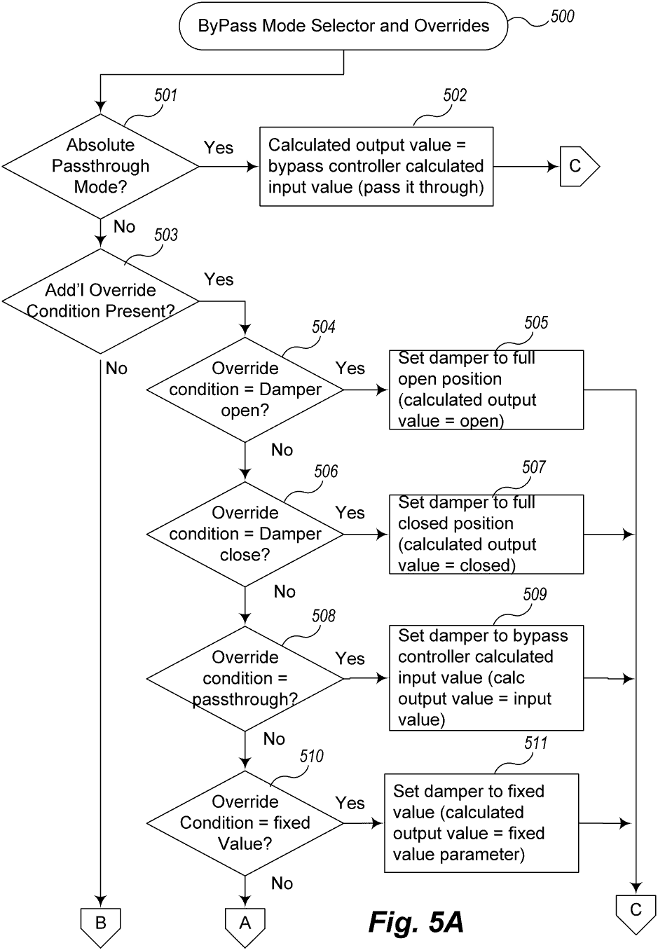

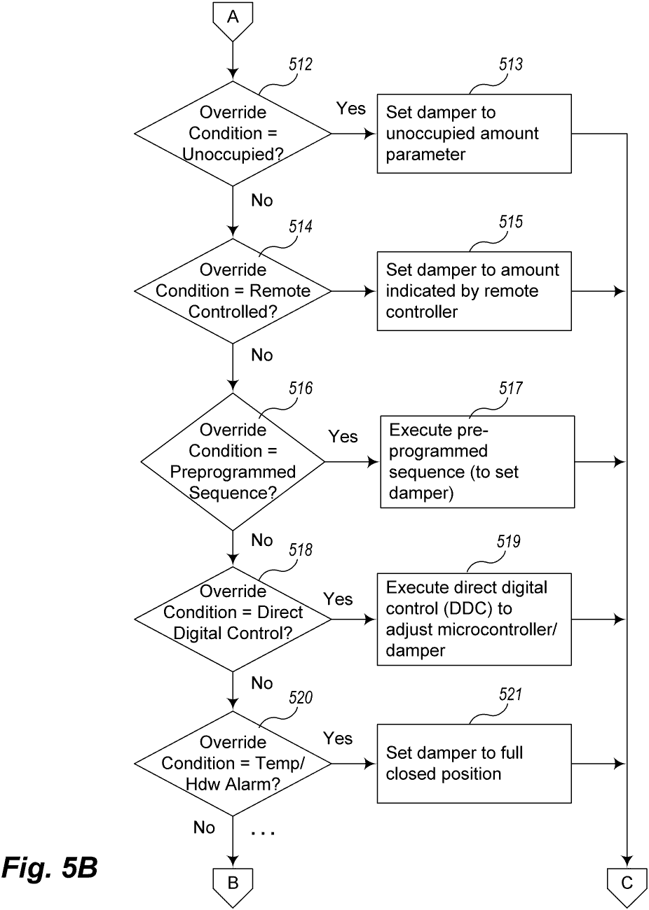

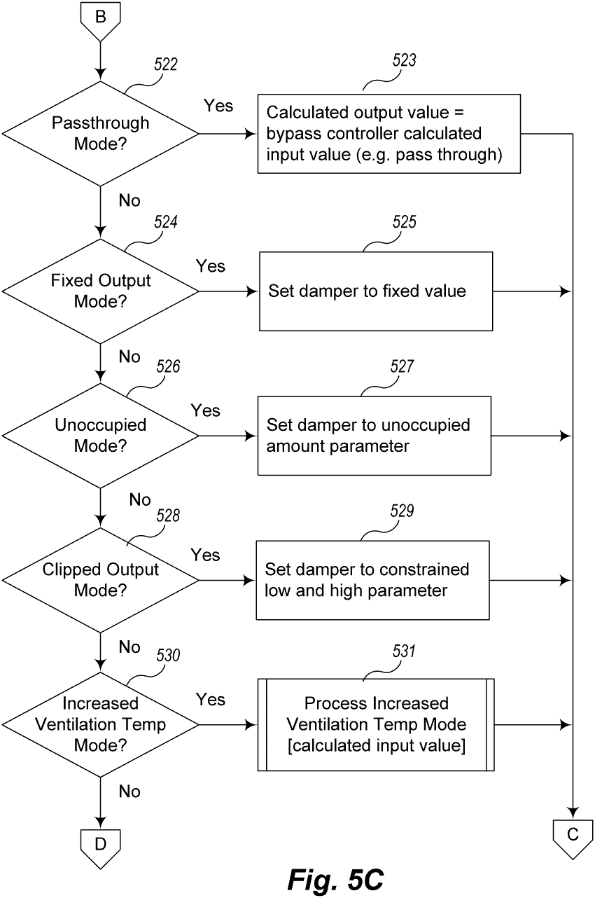

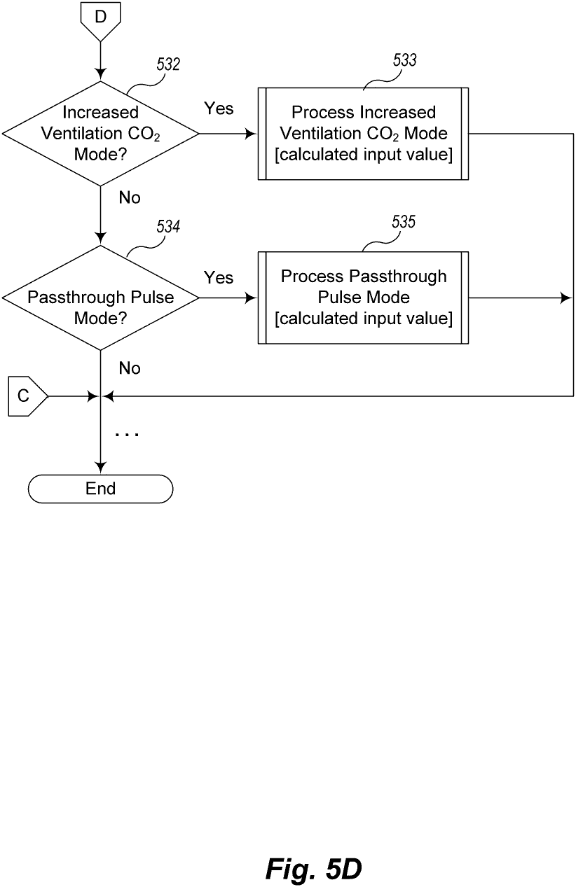

Thus, the EBC provides a unique solution to controlling bypassing the economizer controller 101 transparent to the occupants in the building. To provide this bypass capability, the EBC offers a variety of EBC ventilation modes, discussed further below with respect to FIGS. 5A-8, that determine, based upon received inputs from its own bypass controller temperature and environmental sensors 201, whether to pass the signal along directly from the economizer controller 101, produce a different signal, or override one of its own bypass modes (or further its own other override settings). By including its own bypass controller temperature and environmental sensors 201, the EBC 202 is able to perform totally independently from any existing economizer controller 101 and as such is economizer controller “agnostic.” The EBC 202 can be added to a completely operational, well-tuned economizer system and still choose the best bypass mode to produce the best results. Alternatively, EBC 202 can be attached to an inoperative, malfunctioning, missing, inefficient, or obsolete economizer that does nothing or little to nothing, select a simple EBC ventilation mode, and still produce a solution that meets real needs for increased ventilation in emergency enhanced ventilation COVID times or reduced ventilation in smoke condition times. That means that existing economizers that are designed to be efficient can be nudged off that design point towards increased ventilation for COVID safety and decreased ventilation for smoke conditions by the EBC 202. Thus, the EBC 202 can operate virtually anywhere and in virtually every situation.

In one example EBC 202, the sensors 201 are at the end of six-foot cables (or at least at a sensical length) so they can be stretched out and reach into the correct physical space in and around the air mixing device 102. These cables are shown as return air temperature cable 204 and outside air intake temperature sensor cable 203. The outside air intake temperature sensor cable 203 is placed to sense the temperature of the air that is entering the mechanical cooling section of the HVAC unit 102. If that air gets too cold because of its percent of outside air then no matter what the economizer controller’s goal or the EBC’s goal, the damper louvers 106 must be throttled down so that the cooling coils of the HVAC unit 200 don’t freeze. The other temperature probe attached to cable 204 is placed to sense the temperature of the return air from the building 111. Return air temperature is a pretty good proxy measurement for the air temperature in the occupied spaces (in the building).

Accordingly, the EBC 202 uses the input from the sensor attached to cable 204 to measure return air temperature from the building to signal to the EBC 202 when it is time to stop overriding the existing economizer control signal. For example, the EBC 202 may use this signal to stop overriding (bypassing) the economizer control signal to force increased ventilation, because there isn’t enough energy in the HVAC system 200 to keep the space temperature at a particular level, and by proxy the return air temperature 111, at a stable setting.

Other EBC bypass ventilation modes do not take the return air temperature into consideration. They are designed to address the cases such as where a relevant authority dictates a condition something like, “fix the outside air damper at 82.5% open.” or “never let the dampers close to more than 77% open.” There are many different modes available and contemplated, even those beyond those discussed here.

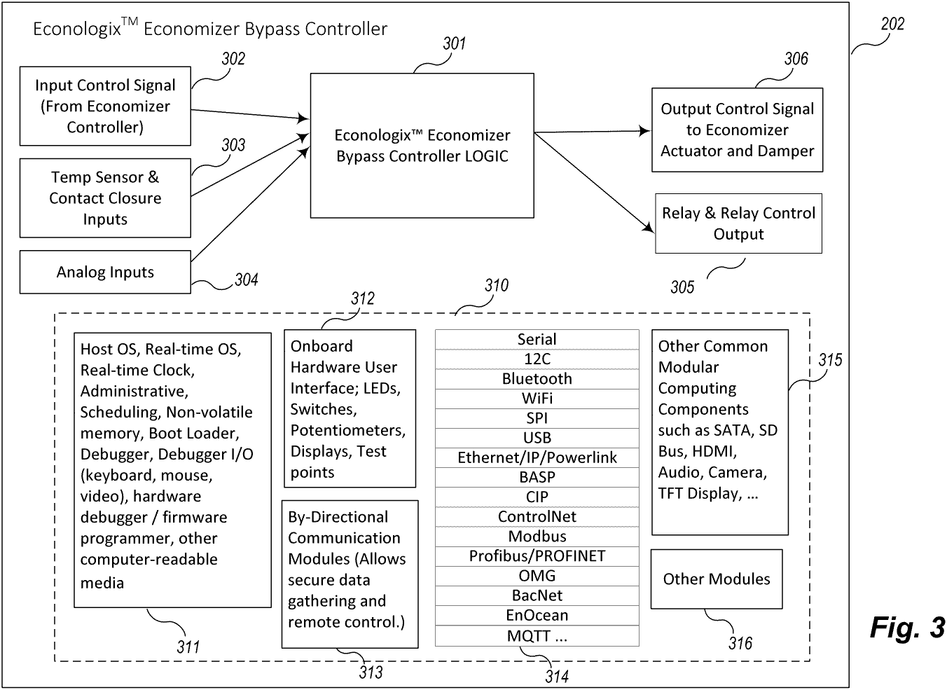

FIG. 3 is an example block diagram of components of an example Economizer Bypass Controller. The EBC 202 shown in FIG. 3, is one with a plethora of components that can interface to other devices as do other computer systems. An example EBC 202 such as the ECONOLOGIX™ Economizer Bypass Controller may take a variety of forms. Other versions of an EBC 202 include a subset of one or more of these components including a simplified device that is controlled without using a microprocessor. The examples described here are often regarding those that have a fully equipped EBC, but it is to be understood that they too can be simplified although in some instances this will impact available functionality. For example, a very simplified EBC without a microcontroller will likely not be controllable by a remote control device.

The example EBC 202 illustrated includes EBC logic (computer instructions 301), an input control signal 302, temperature sensor and contact closure inputs 303, analog inputs 304, output control signals 306, and relay and relay control output 305. In addition, many other components 310 may be present, including computer system controller components 311, hardware interfaces, displays and switches 312, bi-directional communication modules 313, communications modules 314, other common modular computing components 315, and other modules 316.

In one example EBC 202, the input control signal 302 comes from an existing economizer controller such as economizer controller 101 and contains the 0-10V, 0-20mA, pneumatic, floating, or other standard industrial control signal that controls the existing economizer damper unit 104 by sending signals to damper actuator 105.

The simplest bypass (override) EBC ventilation modes do not use this signal. Other EBC ventilation modes use this signal to apply all the existing system “brains” for most effective control of the existing economizer dampers under the selected bypass override mode.

The temperature sensor and contact closure inputs 303 map to the EBC temperature and environmental sensors 201 in FIG. 2. This allows the EBC 202 to operate independently of the existing economizer control with respect to basic temperature inputs as explained above. Two fundamental temperatures are needed to be sensed by the EBC: the temperature of the air blowing into the cooling section (as measured via cable 203). If this air is too cold the cooling section of the HVAC unit 200 could freeze up. The other fundamental temperature is the temperature of the air returning from the occupied spaces (as measure via cable 204), which as explained is used as a proxy for the temperature within the occupied spaces.

As well, the engineering of temperature sensing also allows these inputs to detect short and open circuits. Therefore, unused temperature inputs can be used as “dry” switch contacts. A “dry” switch contact is a simple switch closure that carries no voltage or current. It simply connects an open or short circuit between the contacts. This method of interfacing industrial devices leverages the existing system design requiring only a simple switch.

Other universal inputs (e.g., analog inputs 304), for example that input signals in the 0-10V range can be used to improve the performance of the EBC by adding additional information. Examples of signals that can be attached to universal inputs include CO, CO₂, VOC, SO₂, and NO₂ level monitoring signals, switching signals, humidity level signal. However, many of these inputs are digital networked devices so the input will come as digital information over the network connection.

Using the two input types, including the temperature sensor inputs that can detect open and closed circuits and the 0-10V universal inputs, the following inputs can be measured:
Signal to close damper for emergencies, fire, maintenance.
Signal to open damper for building flush operations.
Signal to force passthrough mode operation.
Signal showing building occupancy.
Signal implying “bad” air, perhaps high CO₂ or other compounds, long occupied time without flush, occupancy levels.
Signal showing heat energy of air (Enthalpy Sensor).
Other signals that become available.
Existing HVAC systems implement these communication signals in a variety of ways depending on the existing HVAC system’s design. For example, the building occupied signal, a simple two-state “yes” or “no” signal can be implemented in a variety of ways. It might be implemented as a “dry switched” open or short circuit, a 0 or 10VDC signal, or a 0 or 24VAC signal (switching of the same voltage that powers the EBC as it might be the only non-zero electrical signal available). These signals are equally valid ways to represent the building occupied state and they are easily transduced from one to another. Depending upon the hardware available in any specific EBC implementation, this type of signal can be detected in multiple ways. A CO₂ level input, as a contrasting example, is a true analog signal where a specific voltage represents a specific CO₂ level. Therefore, analog CO₂ signals must be received from a universal 0-10V input.

When advanced, network communications are available in an EBC and connected to reliable networked sensors and a reliable network, all the inputs could come from networked sources, instead of, in addition to, or in some mix with the analog inputs 304.

The EBC logic 301 is where all the work of the economizer bypass controller occurs. The EBC logic 301 includes the circuits, processor, memory, components, logic, firmware, circuits, and/or software to implement the bypass and override mode functions as described further below.

The output control signal 306 is the reconstructed input control signal 302 as modified by the logic 301 implemented in the selected mode connecting to the damper actuator 105. Thus, signal 306 is sometimes referred to as the “calculated” output signal. This signal will be of the same format as the signal from the existing economizer controller 101. The existing damper actuator 105 will not “know” that the calculated output signal coming from the EBC is anything other than its input control signal (it is the same to the damper actuator 105 regardless of whether its input control signal comes from the existing economizer 101 or the EBC 202).

In some EBC 202 examples, additional analog output signals (not shown) are made available depending upon the hardware available in any specific EBC implementation. For example, the EBC 202 can output analog information pertaining to the performance of the EBC 202 itself. For example, when operating as a “floating control” device, the equivalent analog output (e.g., 0-10 V representing 0-100% damper opening) can be produced for display or confirmation. Other examples of outputs include self-detected error or alarm indications, such as a temperature probe failure or a temperature out of range notification.

Relay and relay control output 305 is used when the EBC 2020 is operating as a floating control device. The relays are used to manage the open and close actuator signals for the damper actuator 105. The relay and relay control signals 305 can be used to provide alarm notification as well. The difference between the relay and relay control signals is that the relay control signal is a logic level signal that is “ON” when the relay is energized. This logic-level signal can be used directly for signaling if it is more convenient than the relay outputs, or it can be used to power SCR switching devices.

Other components 310 may be present. For example, computer system components 311 contains all the physical hardware, firmware, circuit, and software components necessary and traditional for implementing, developing, maintaining, updating, and using computing device-based controller. When reducing the features of an EBC 202 down to those can be implemented without a processor components 311 represents the pedestrian components that are necessary and traditional for creating a non-processor-based controller.

Onboard hardware interfaces, displays and switches 312 comprises the important user feedback and control components of the EBC 202. Other bidirectional communication methods may exist but it is always important to have some level of user control and feedback at the physical device level. Because these user interface components are implemented in hardware it is important to keep them simple and low-cost yet sufficiently powerful to control and understand the device.

Bi-directional communication modules 313 comprise multiple physical communication methods, hardware, and interfaces that have become standard and traditional on computing devices. More and more are “free” on microcomputing platforms. Some are limited by speed or distance, others can connect to the internet and distance becomes irrelevant.

Communication modules 314 includes many types of network and other communications logic, protocols, and interfaces for connectivity purposes. For example, following logic, drivers, interfaces, etc. may be present in any EBC implementation:
Serial Long tradition of use in computer systems and industrial control applications. Extremely cheap and can transmit information over long distances using an inexpensive 3-wire cable. There is no “standard” communication protocol for serial communications. Logic Level, RS-232, and RS-485 signal levels are possible with appropriate hardware implementations.
I2C A serial bus protocol that is usually used within an imbedded controller device but can be used to extend the capacity of the device with other input and output peripherals over a very short distance, no more than a few meters.
SPI Another serial protocol that has been a standard for a very long time. Also for short distance communications. Faster than I2C but has 4 wires.
USB The Universal Serial Bus is the most common interface between computers and other devices. Often the USB cable is used for the power feature that is part of the specification.
Bluetooth A standardized wireless technology use for sending data between two devices using radio waves.
Ethernet A physical wire connection that allows computing devices to connect to the internet.
WiFi A standardized wireless technology that allows computing devices to connect to the internet without a cable.

Over the internet connections there are a variety communication protocols that have been implemented, some proprietary, some open. The Ethernet Industrial Protocol, or Ethernet/IP, uses the open Ethernet link layer (wires and WiFi) and Internet Protocol networking layers with the potentially additional applications layers below:
Modbus TCP An extension of the standard Modbus communication protocol that operates over the internet is considered by many to be the de facto standard of industrial electronic devices.
OMG An IOT protocol that is currently in the process of becoming a recognized standard.
BACnet™ This protocol is specifically designed for Building Automation and Control networks for applications such as HVAC, lighting, access, fire detection, and related control. This protocol allows all devices to share information without regard to the service they perform. ASHRAE (American Society of Heating, Refrigerating and Air-Conditioning Engineers) owns the BACnet™ protocol.
MQTT The Message Queuing Telemetry Transport protocol is an ISO standard protocol that transports messages between devices used primary in the IOT industry. Products like IBM’s Node-RED development tool use this protocol. It is being implemented in more and more automation and control applications.
EtherCAT (Ethernet for Control Automation Technology) An open-source protocol optimized for automation requiring fast data communication times. It promises reduced hardware costs.
Ethernet Powerlink A real-time protocol for standard Ethernet.
CC-Link Open Automation Networks Originally developed by Mitsubishi Electric Corporation and released as an open network so that others could incorporate the standard into their products. It is interoperable with PROFINET.

It is noted that newer sensor technology likely will move towards digital networked protocols, especially for sensors that require significant electronics to implement. Some such sensors include CO, CO₂, VOC, SO₂, NO₂, and humidity level signals. Even simple temperature sensors will probably move towards digital network protocols rather than analog signals as they can be monitored in multiple locations without additional wiring.

The bi-directional communications physical modules 313 in conjunction with one or more of the communication modules 314 (protocols, languages, logic, etc.) support output datalogging of all input data, output data, and internal device performance data. The physical communication method and the protocol format of the datalogging is controllable to the extent of the capacity of the hardware and software implementation supported by modules 313 and 314. Combining output datalogging and a remote control interface using the capabilities of the components 313 and 314 allows for the possibility of implementing totally new algorithms “in the cloud” in other EBC implementations. For example, it is contemplated that cloud-based software could integrate weather conditions and predictions using existing internet sources and implement adaptive, “intelligent” strategies for further EBC ventilation modes. Further, integration with internet-enabled building sensors that may or may not even exist could be implemented and incorporated in an EBC.

Other common modular computing components 315 may also be present in some example EBCs. Some modular microcontroller designs have become so integrated that other common computing modules are almost “free”. In the context of the EBC some of the modules that are useful include a SATA and SD Bus for non-volatile input and output datalogging as well as storing internal device performance data. This is useful for evaluating the performance of the existing economizer controller and the EBC in the actual context. Having audio capacity can improve the human interface. The TFT display modules can provide plug-in enhanced displays for maintenance work. The addition of a camera has can provide remote inspection capacity that would lower maintenance costs.

An important modular computing component for higher-end EBC implementations is an on-board battery backup mechanism to ensure the computing device has enough powered time after loss of power to bring the control signal outputs, alarm signal outputs, by-directional communications subsystems (and the last alarm messages to be sent out over them), and the device’s own operating system to a clean, ready-to-be-shutdown state. This interacts with the fault detection and compliance block when appropriate.

Other modules 316 may also be included in an EBC implementation. For example, the EBC 202 may also include (not shown) pre-programmed sequences (which are stored), scheduling and remote control interface. Pre-programmed damper control sequences provide shortcuts for maintenance and emergent situations. Typical damper actuators take over 90 seconds to completely open or close the dampers. Pre-programming sequences translate directly into time savings for technicians on the roof. Coupled to a modular camera and an internet connected device, remote maintenance can be applied to HVAC systems that are difficult and expensive to check more than absolutely necessary. Further, pre-programmed sequences can be initiated by relatively untrained people because the human interface skills needed to activate a pre-programmed sequence are much simpler than the specialized training needed to open up and tinker with a running HVAC device.

The scheduling and remote control interfaces (not shown) is a generalization of the pre-programmed sequences function that can be implemented on sufficiently powerful EBC implementations that allows for an arbitrary schedule of mode changes, pre-programmed sequence changes, and parameter changes. These schedule elements are stored in the EBC device’s memory so that they can be implemented even if communications are not working. Examples of scheduling events may include work week / weekend schedules, holiday schedules, scheduled maintenance, and the like.

Secure remote control operations allow for both complete remote setup of the device and ad hoc mode, pre-programmed sequence, and parameter changes. With sufficiently clever remote-control software, robust scheduling, including integration to external scheduling software, can be implemented in an EBC. Additionally, with sufficiently clever remote-control software, ad hoc maintenance, testing, verification, and override operations can be implemented. The industry term, “Direct Digital Control” (DDC) describes this lowest level of control. Over time and manufacturer implementations, the term DDC describes the idea that the EBC can be fully controlled remotely.

Pre-programmed sequences, scheduling, and remote control interface capacity are implemented may be present in a variety of EBC devices, all the way down to the most simple hardware implementation where only serial output is available.

In some example EBCs, fault detection and reporting is available. In some example EBCs, the EBC translates specific measured faults and creates alarm notifications via email, universal outputs and LEDs. Fault detection may include loss of power, low return air temperature, temperature probe failure or a temperature out of range, failed damper positioning, freezing conditions, loss of output signal - when the detection of such faults is possible.

Some EBC devices offer simplified EBC setup for some economizer controllers with demand ventilation control options (such as existing Trane and Honeywell economizer controllers). A default EBC setup conceptually is a drop in, “cut & place” operation between an existing economizer and its existing damper actuator. This allows the EBC to be used on almost any economizer setup, especially considering when floating control capability built into the system.

These existing economizers have an override feature built into the economizer controller/actuator system, usually called something like “remote set point”. This is envisioned as an upgrade path for larger, more integrated control systems. However, this same feature can be used as a very simple connection to the EBC output. Whenever a control signal is presented at the “remote set point” this signal bypasses the existing economizer/actuator logic and presents this signal directly to the damper actuator.

When operating in this mode, the EBC would have no existing economizer input so only the fixed output modes, or total Direct Digital Control (DDC) operation (as described with reference to FIGS. 5A-5D) would be meaningful. However, the extreme installation simplicity of not having to cut any wires at all and inserting the EBC into an existing economizer system and simply connecting the output of the bypass controller to the remote set point input, and the cost savings of an EBC model sometimes may justify the reduced features available.

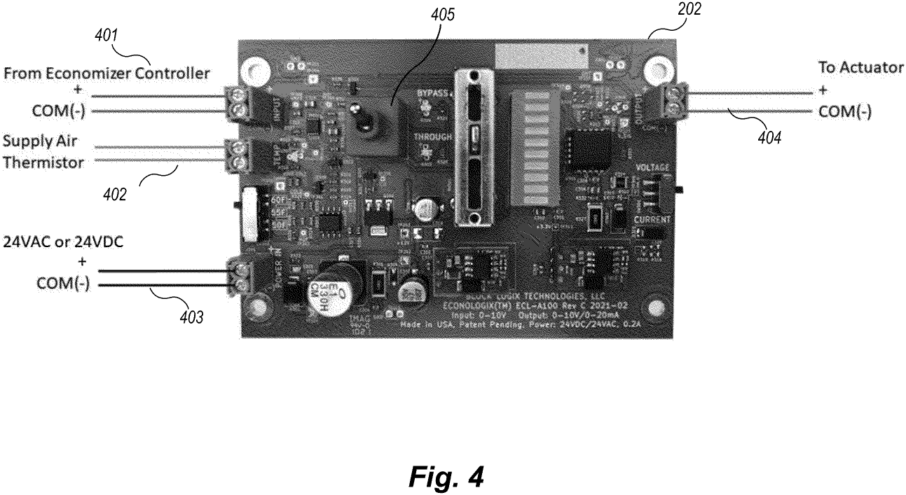

FIG. 4 is an example Economizer Bypass Controller board showing example inputs and outputs. FIG. 4 is an example of a simplified EBC 202 without a microprocessor. No changes are necessary to the existing economizer controller or the damper unit to install the EBC 202. The wiring requirements can be completed quickly. Specifically, the EBC 202 is connected to the economizer-to-damper control signal wire 401. The EBC 202 is also connected to the supply air temperature sensor 402. The 24VAC or VDC power and common wires 403 are then connected to the EBC 202. Installation time onsite is about one hour, including health emergency specific settings. Typical onsite time to change a settings averages less than 10 minutes. As shown on the board, there is a single switch 405 to change between bypass and passthrough modes. There are no physical changes required to economizer, damper, mechanical linkages, or other electrical connections.

Emergency bypass ventilation settings are accomplished by simple manual positioning of outside air damper using slide control and LED feedback. For smoke conditions, the damper position is adjusted to a desired minimum (closed) setting. For increased ventilation needs (e.g., for COVID-19), the damper position is adjusted to a desired maximum (open) setting.

As described above, the EBC 202 even in its pared down configuration provides protection in passthrough mode. Below approximately 50° F. supply air in bypass mode, the EBC 202 outputs a zero-signal closing the outside air dampers limiting equipment damage from freezing conditions and comfort issues from admitting cold outside air into the controlled space.

The examples described herein often refer to retrofitting an existing economizer controller into an existing HVAC rooftop unit. It is to be understood that the techniques described herein can also be integrated into new (e.g., not yet installed or newly manufactured) HVAC RTUs. In addition, the concepts and techniques described are applicable to other controllers, including other types of HVAC systems including Heat Pump Systems, Air Handling Units (AHU) (e.g., which generally include a larger implementation of a packaged rooftop unit), Unit Ventilators (Uni-Vent) (often used in smaller environments such as school classrooms), Variable Air Volume (VAV Systems), Energy Recovery Ventilators (ERV), Make Up Air Unit (MUA) (often used in kitchens, warehouses, and gymnasiums), and the like. Essentially, the concepts and techniques described are applicable to any environment that requires comfort cooling or ventilation where free cooling or economizers (using outside in conjunction with mechanical cooling) are used to maintain temperatures and/or improve indoor air quality in occupied building spaces.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement an EBC device to be used for bypassing and/or overriding economizer controller output and other emergencies. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

As described in FIGS. 1-4, one of the functions of a Economizer Bypass Controller is to bypass the economizer controller through bypass ventilation modes.

FIGS. 5A-5D is flow diagram of example bypass mode and override selection routine of an example Economizer Bypass Controller to provide bypass and override capabilities between an economizer and a damper actuator. In overview, the logic illustrated therein describes two main operating conditions of an example EBC, such as EBC 202. The first is “normal” bypass conditions and the second are “override” conditions. Of note, all bypass conditions and overrides that don’t just pass through an existing economizer controller output signal are considered “overrides” of the economizer controller. These two conditions are intended for describing overrides of the bypass controller (e.g., EBC 202) itself. Thus, depending upon how the override condition logic is ordered, the EBC can implement a hierarchy of override conditions based upon the first override condition encountered. Alternatively, a hierarchy of override conditions can be coded into the logic itself. Also of note, one could structure the same logic as all bypass modes. All such alternatives are contemplated.

Controls to enter these EBC operating conditions come either from a human interface of the device, input signals coming into the device (e.g., from sensors or from the economizer controller outputs), or some type of communication information received by the device using the communications modules and protocols described above with respect to FIG. 3 (modules 313 and 314). Almost every operating condition can be entered multiple ways. The logic does not try to describe “how” a state is entered, only the effects of operating in that specific state. For example, a human interface may be used to put the EBC into a particular mode.

The bypass modes and override conditions shown in FIGS. 5A-5D are examples. Others may be included and some may be changed or omitted. For all bypass modes and override conditions, the single-wire proportional percentage or two-wire floating control type is maintained. Both humans and the EBC’s internal algorithms use a concept of “percent open” as the main control variable. Floating control devices operate with two different signals but these two signals are integrated to calculate the percentage signal used for inputs and recreated to make the required floating control output signal. Thus, in the following description, “calculated” input or output values refer to incorporating these conversions from and to proportional percentages as need.

Note, when an existing floating controller type economizer is used and the EBC is in a non-overridden, not absolute pass-through mode case, the output signals to the damper actuator are not necessarily matching the input signals from the existing economizer. This means that the existing economizer’s re-indexing operations must be monitored and recreated for the damper actuator. Re-indexing operations are implemented as pre-programmed sequences and initiated internally when an existing economizer re-indexing operation is detected.

In FIGS. 5A-5D, bypass mode selector and override logic 500 operates as follows. Again, this is an example of how they EBC logic may be programmed and other equivalent logic may be incorporated. In essence, blocks 501 and 522-535 implement a check for each bypass mode and blocks 503-521 implement logic for the currently recognized override conditions. The user interface of an EBC device may be used to set certain default parameters.

In block 501, the logic checks to see if the EBC has entered absolute passthrough mode. If so, the logic continues in block 502 to enter absolute passthrough mode. If not, the logic continues to block 503. Absolute passthrough mode connects the input control signal from the existing economizer (single-wire proportional percentage or two-wire floating control to the output going to the damper actuator (matching single-wire proportional percentage or two-wire floating control) without any change for any reason. This mode may be used when the existing system is working perfectly for the situation. The EBC does nothing to the signal in any way. Specifically, in block 502 the logic sets the calculated output value sent to the damper actuator to the EBC’s calculated input value. The logic then completes.

In block 503, the EBC logic checks for the presence of override conditions which determine whether the current operating mode needs to be changed for a specific reason. The absolute passthrough mode is the only mode that does not check for override conditions first. All other modes described below include examination for override conditions first. Blocks do not consider the priority of the override condition, just the main override conditions that may arise. Other override conditions, or other orders can be similarly accommodated. In some EBC implementations, these orders and conditions are configurable via an EBC user interface (not shown).

If an override condition is present, then the EBC checks which override condition is present, otherwise continues to block 522. Blocks 504-521 implement these override conditions.

Specifically, in block 504, the EBC logic determines whether the override condition indicates to force the damper to a fully open position. If so, the logic continues in block 505 to set the damper to its full open position, which means setting the calculated output value to “open,” and then ends. For example, this override could be used for building flush, maintenance, floating control indexing. A physical input for this override condition is a priority for all but the simplest hardware implementations. If this override condition is not present, the EBC logic continues to block 506.

In block 506, the EBC logic determines whether the override condition indicates to force the damper to a fully closed position. If so, the logic continues in block 507 to set the damper to its full closed position, which means setting the calculated output value to “closed” and then ends. For example, this override could be used for emergency shutdown, fire, extreme low temperature, maintenance, floating control indexing. A physical input for this override condition is a priority for all but the simplest hardware implementations. If this override condition is not present, the EBC logic continues to block 508.

In block 508, the EBC logic determines whether the override condition indicates to force the damper to a passthrough mode so that the output exactly matches the input. If so, the logic continues in block 509 to set the EBC calculated output value (to control the damper actuator) to the EBC calculated input value, and then ends. For example, this override could be used for maintenance, testing, and to take advantage of advanced features or control implemented in the existing economizer system when no override strategy is needed. Advanced features could include taking advantage of existing scheduling capacity in the existing economizer. If this override condition is not present, the EBC logic continues to block 510.

In block 510, the EBC logic determines whether the override condition indicates to force the damper to a specified fixed position already set in the device’s non-volatile memory (such as, for example, result of user configuration). If so, the logic continues in block 511 to set the EBC calculated output value to this fixed value parameter, and then ends. For example, this override could be used for testing, maintenance, or when a specific need arises for the dampers to be in a specific, preset position. The specific position could be fully closed or fully open meaning this override mode is a general way to preset the damper to any fixed position, which may be configurable in any particular EBC implementation. If this override condition is not present, the EBC logic continues to block 512.

Of note, whether or not explicitly mentioned in a logic block of FIGS. 5A-5D, setting the damper to some parameter or to some position implies that the EBC calculated output value is being set as input to the damper actuator. For ease of description, this calculation is not shown in further logic blocks of FIGS. 5A-5D although it is assumed to be present.

In block 512, the EBC logic determines whether the override condition indicates to force the damper to a position already set in the device’s non-volatile memory (such as, for example, result of user configuration) reflecting that the building is unoccupied. If so, the logic continues in block 513 to set the EBC calculated output value to this unoccupied parameter to set the damper accordingly, and then ends. For example, this override could be used for ease of temporally overriding the currently running mode and change to the unoccupied damper position. The specific position could be fully closed or fully open meaning this override mode represents a general way to preset the damper to any independent fixed position, which may be configurable in any particular EBC implementation. If this override condition is not present, the EBC logic continues to block 514.

In block 514, the EBC logic determines whether the override condition indicates to force the damper to an amount indicated by a remote control device. If so, the logic continues in block 515 to set the EBC calculated output value to the value communicated in a remote control message to set the damper accordingly, and then ends. This override is functionally the same as the fixed overrides in blocks 510-513 with the difference that the entry method is sent to the EBC by some external communication method and the damper actuator position is communicated with the override message. Therefore, this override method can be considered a more dynamic override method. Terminating this override method must be provided by another communication message to do the next thing. If this override condition is not present, the EBC logic continues to block 516.

In block 516, the EBC logic determines whether the override condition indicates to initiate a pre-programmed sequence to control the damper unit. If so, the logic continues in block 517 to execute the pre-programmed sequence to set the damper accordingly, and then ends. When the pre-programmed sequence is finished the override is complete and the device returns to the current non-overridden mode. Floating control re-indexing maneuvers are an example of pre-programmed sequences. If this override condition is not present, the EBC logic continues to block 518.

In block 518, the EBC logic determines whether the override condition indicates to initiate direct digital control to control the damper unit. If so, the logic continues in block 519 to execute the direct digital control to set the damper accordingly, and then ends. This override condition represents an even more generalized override method that not only changes the EBC’s output but can update the EBC’s non-volatile memory to change settings and operational parameters. If this override condition is not present, the EBC logic continues to block 520.

In block 520, the EBC logic determines whether the override condition indicates to initiate that some type of hardware “alarm” or malfunction condition has occurred. If so, the logic continues in block 521 to set the damper to a fully closed position (or some other configured parameter corresponding to the alarm condition, and then ends. If this override condition is not present, the EBC logic continues to block 522.

In block 522, after all of the override conditions have been accounted for, the EBC logic determines whether to enter passthrough mode. If so, the logic continues in block 523 to enter passthrough mode, and then ends. This mode connects the input control signal from the existing economizer to the output going to the damper actuator. This is used when bypass conditions are not required (such as health requirements are not indicative of increased or decreased ventilation) and sets the damper similarly to block 502 described above. If this passthrough condition is not present, the EBC logic continues to block 524.

In block 524, the EBC logic determines whether to enter fixed output mode. If so, the logic continues in block 525 to set the damper to a predetermined value, for example, configured as a parameter and operates similar to block 511 described above, and then ends. This mode sends a fixed output signal to the damper actuator. This is used when the bypass requirements are expressed as fixed percentages or settings. For example, set the damper to 87% open. This mode can also be used when the existing economizer is turned off or has malfunctioned to provide a fixed damper opening. If this fixed output condition is not present, the EBC logic continues to block 526.

In block 526, the EBC logic determines whether to enter unoccupied mode. If so, the logic continues in block 527 to set the damper to a predetermined value corresponding to an unoccupied building setting, for example, configured as a parameter and operates similar to block 513 described above, and then ends. This mode provides another fixed output setting specifically designed for long unoccupied periods. In an example EBC, there are two different user interface settings for fixed and unoccupied modes so that they can be used independently and switched between as needed. If this unoccupied condition is not present, the EBC logic continues to block 528.

In block 528 the EBC logic determines whether to enter a clipped output mode. If so, the logic continues in block 529 to set the damper to a predetermined value corresponding to a clipped output setting, for example, configured as a parameter, and then ends. This mode may be considered the simplest of the intelligent modes to optimize the best performing existing economizer systems with health considerations. Here the existing features of the existing economizer are used to control the damper actuator - as long as the damper actuator is operating between a preset low and high value (thresholds). For example, the relevant authorities may mandate a damper opening of over 80% for increased ventilation to address COVID-19 concerns. Configuring the clipped output mode low and high parameter values at 80% and 100% means that whenever the existing economizer’s optimization algorithm opens the damper between 80% and 100% the signal is passed thru. However, when the existing economizer tries to position the damper to less than 80%, the EBC maintains (or forces) the 80% minimum. The EBC operates similarly to address smokey conditions. Here the low and high limits may be set for 0% and 10%. As long as the existing economizer tries to position the damper between those limits the signal is passed through but the EBC will not let the damper open more that the specified 10%. If this clipped mode condition is not present, the EBC logic continues to block 530.

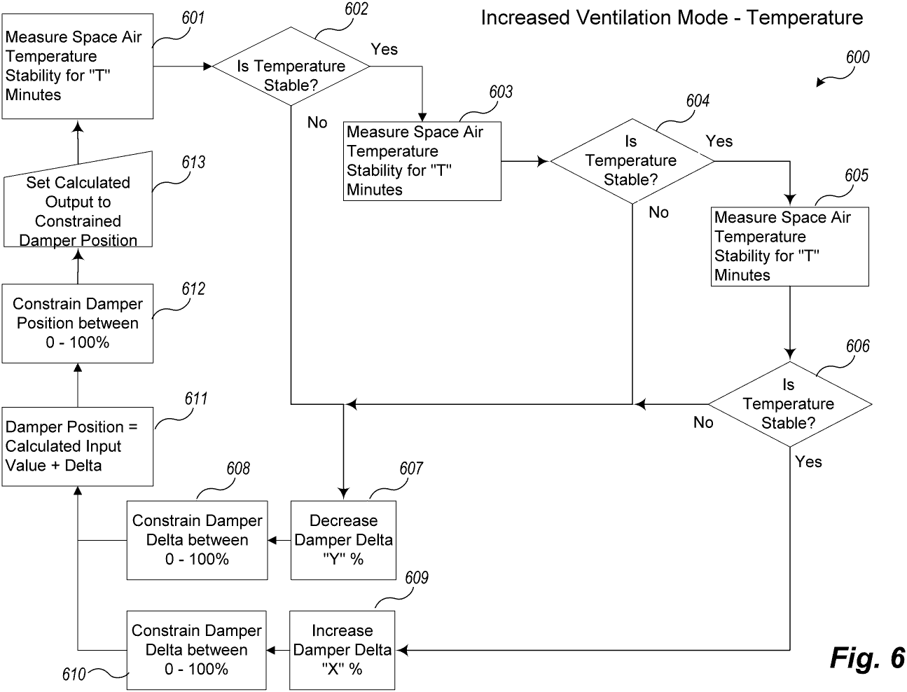

In block 530, the EBC logic determines whether to enter increased ventilation temperature mode. If so, the logic continues in block 531 to execute logic for increasing ventilation using information from the temperature sensors, and then ends. This mode implements an algorithm inspired by the ASHRAE Increased Ventilation algorithm. The EBC version has increased flexibility, but the general idea is to automate a process somewhat similar to the centuries-old process of “open the window a little more if the temperature inside is OK, otherwise, close it a bit.” This logic is described further with reference to FIG. 6. If this increased ventilation temperature mode is not set, the EBC logic continues to block 532.

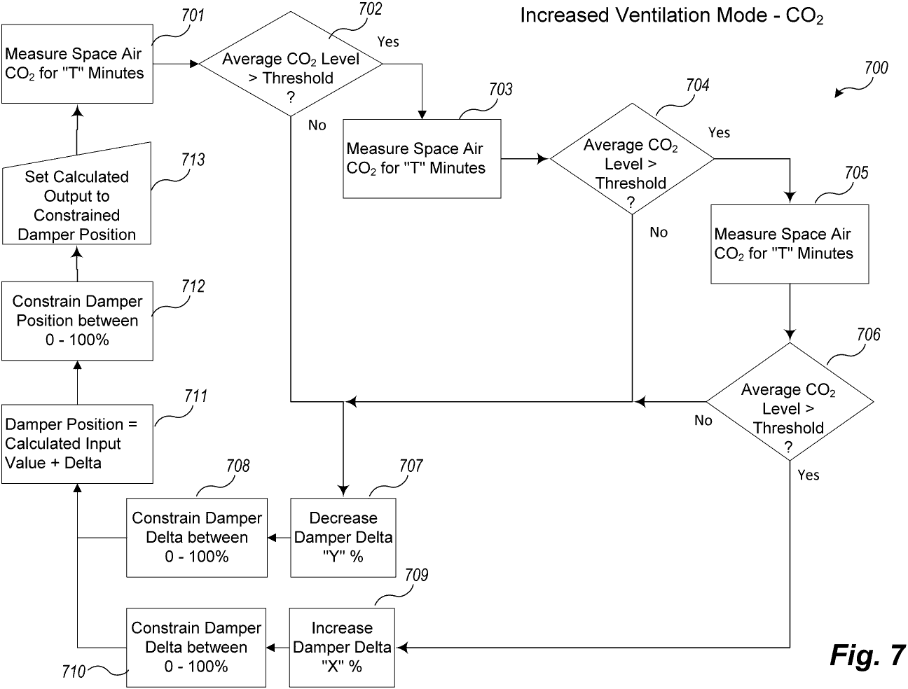

In block 532, the EBC logic determines whether to enter increased ventilation CO₂ mode. If so, the logic continues in block 531 to execute logic for increasing ventilation using information from the sensors, and then ends. This logic is described further with reference to FIG. 7. If this increased ventilation CO₂ mode is not set, the EBC logic continues to block 534.

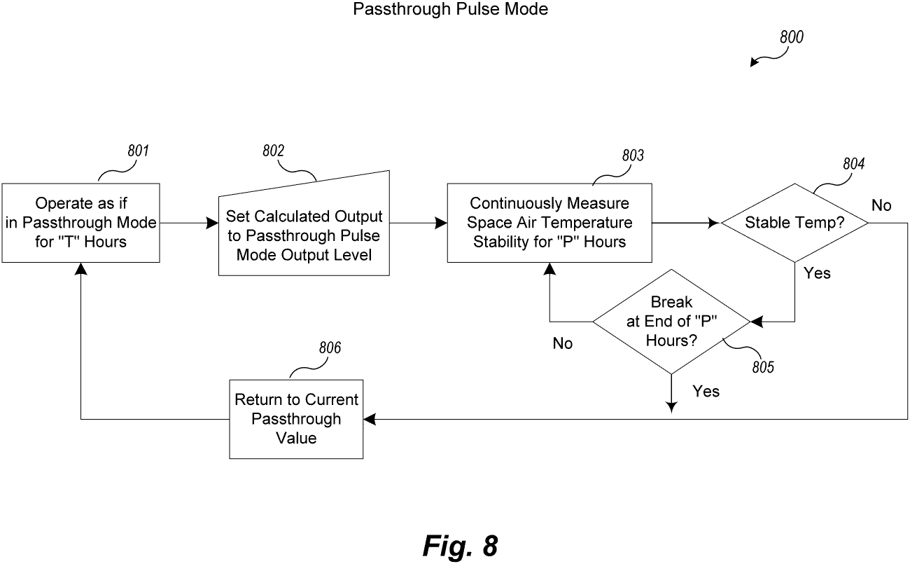

In block 534, the EBC logic determines whether to enter passthrough pulse mode. If so, the logic continues in block 535 to execute logic for increasing ventilation using information from the temperature sensors, and then ends. This logic is described further with reference to FIG. 8. If this passthrough pulse mode is not set, the EBC logic ends.

FIG. 6 is an example flow diagram of an increased ventilation mode routine of an example Economizer Bypass Controller using a temperature sensor to modulate increased damper ventilation. In overview, this logic automates a process somewhat similar to the centuries-old process of “open the window a little more if the temperature inside is OK, otherwise, close it a bit.” Starting in block 601, the logic sends the existing economizer’s signal plus a damper delta value to the damper actuator and measures the space air temperature using the proxy of return air temperature (e.g., the sensor connected via cable 204 in FIG. 2) for “T” minutes. At the end of this time, in block 602 the logic determines whether the space air temperature has stayed relatively unchanged. If it has not remained relatively unchanged, it continues to block 607 to decrease the extra damper opening value (damper delta) a preset amount, being sure this amount doesn’t go below zero (block 608), adds this damper delta to the input signal percent (block 611) and sends this sum to the damper actuator (block 612-613). On the other hand, in block 602 if the space air temperature has been stable for the “T” minutes, the logic continues to block 603-604 to measure the space air temperature for another “T” minutes (block 603) and check for stability again (block 604). If the space air temperature wasn’t stable for this time, then the logic continues to blocks 607-613 to lower the damper delta again and continue to measure in block 601. On the other hand, in block 604 if the space air temperature continues to be stable measure for an additional “T” minutes, then the logic continues to block 605-606 to measure the space air temperature for another “T” minutes (block 605) and check for stability again (block 606). If the space air temperature wasn’t stable for this final time, decrease the damper delta as before (blocks 607-613). However, if the space air temperature has continued to be stable for three measurement periods (blocks 601-606), then the logic proceeds to block 609 to increase the damper delta, and continues to block 610 to ensure that the amount doesn’t grow to more than 100%, adds this damper delta to the input signal percent (block 611) and sends this sum to the damper actuator (block 612-613) to calculate the new damper actuator position.

The logic shown in FIG. 6 is intended to be more conceptual than formulaic. The damper actuator output value is constantly being calculated as the input from the existing economizer controller plus the damper delta rather than as the conceptual one-time-per-stability-measurement shown. The increased ventilation mode logic’s goal is to calculate the damper delta as space air temperature stability allows. As long as the existing HVAC system’s economizer and mechanical temperature system can maintain the space air temperature, the logic will open the damper a bit more and more than the existing economizer is directing. However, when the HVAC system starts to reach the limits of its capacity to keep the temperature constant, and the measured space air temperature becomes unstable, the increased ventilation mode logic then reduces the damper delta. Over time, this algorithm will increase the damper opening to the point where the existing HVAC system capacity is maximized but no further.

FIG. 7 is an example flow diagram of an increased ventilation mode routine of an example Economizer Bypass Controller using a CO₂ sensor to modulate increased damper ventilation. This logic implements similar logic to that described with respect to FIG. 6, except that rather than monitoring space air temperature stability, this mode and logic monitors space Air CO₂ level. The logic shown in blocks 701-713 determines whether the CO₂ level is above the threshold the damper delta will increase to increase ventilation and bring the CO₂ level down. When the CO₂ level is below the threshold value, the damper delta will drop returning the control bias towards the existing economizer. As this mode monitors CO₂, the temperature is not taken into consideration. This means that as the ventilation level increases, the temperature will likely change depending on the HVAC system’s capacity to maintain it. Thus, it is also possible for both logic flows to operate to complement each other.

FIG. 8 is an example flow diagram of a passthrough pulse mode routine of an example Economizer Bypass Controller that provides increased ventilation for set cycles of time (pulsed increased ventilation). This mode implements a passthrough mode with a regular pulse of overridden damper opening time that persists until that opening time is satisfied or the space air temperature becomes unstable. This mode may be useful, for example, to address COVID-19 conditions to force a building flush pulse for a specific length of time or a specific cycle time. Also, this mode can be used for smoke conditions to continue to circulate inside air for a period of time with minimum damper opening to mitigate smoke ingress.

Specifically, in block 801, the EBC logic operates as if in passthrough mode for a time “T” (which may be configurable). At the end of the preset time cycle “T,” in block 802 the damper actuator is set to a preset value and in block 803 the logic starts to monitor the space air temperature for a preset “P” time (which may be configurable). In block 804, if at any time the temperature become unstable beyond a preset limit, then the logic continues to block 806 to return the damper actuator from the preset value back to tracking the existing economizer input value as if in passthrough mode, and continues back to block 801. If the temperature never becomes unstable eventually in block 805 the preset pulse time expires, and the logic continues to block 806 to return the damper actuator from the preset value back to tracking the existing economizer input value as if in passthrough mode, and continues to block 801. In some implementations, the EBC logic after executing block 806 ends.

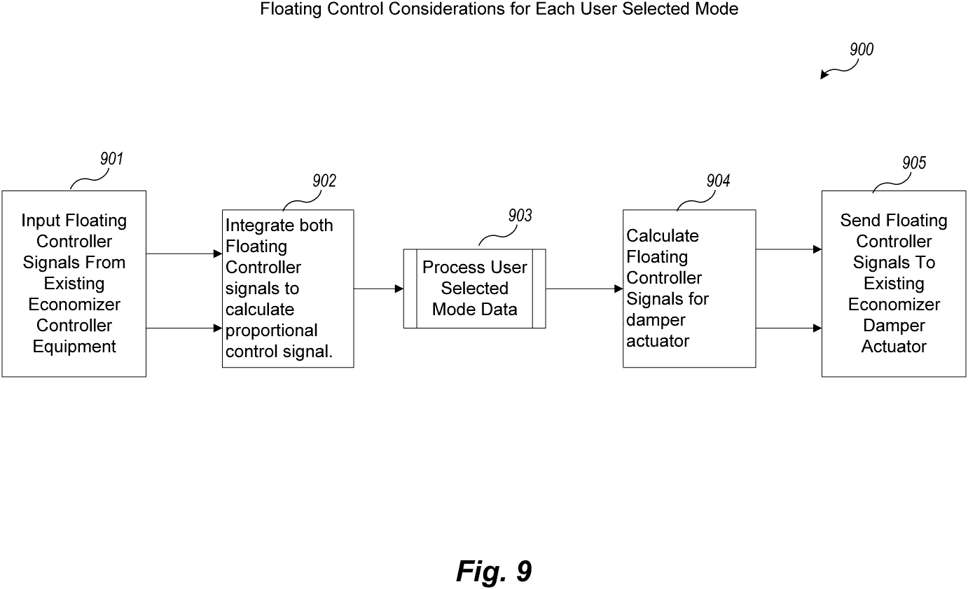

FIG. 9 is an example flow diagram illustrating handling of floating controller economizer adaptation. This logic describes a mechanism to convert from floating control inputs to a percentage and back as used in the prior flow diagrams (FIG. 5A-8).

Floating control devices are relatively simple and inexpensive devices, at least compared to the proportional percentage control devices. One reason for this simplicity is there is no feedback between the controller and the actuator: in the case of using an EBC, there is no feedback between the existing damper actuator and the existing economizer and the EBC. This means that the existing economizer and the EBC do not know where the damper actuator is situated at any given time. For example, at startup, the existing economizer and EBC do know the last position of the damper actuator. It could be fully open, fully closed, or somewhere in the middle. Gusts of wind, grade school children with sticks, maintenance procedures, and malfunctions can change the actuator position from where the EBC expects it.

Therefore, periodically, the existing economizer and the EBC preferably re-index the floating control actuator to force it into a known position by traveling to either a fully closed or a fully open position for longer than the maximum travel time of the actuator. Opening or closing for longer than the maximum travel time ensures that the actuator is in the extreme position no matter where it started. The challenge is that the damper actuator is a slow device and one of common actuators requires 95 seconds to travel from fully closed to fully open. The same for the return trip.

As described above, a goal of the EBC is to disassociate the existing economizer from the existing damper actuator. The only way the EBC “knows” that the existing economizer is doing a re-indexing maneuver is that the close or open signal stays activated for longer than a full actuator travel time. Therefore, not only does the EBC need to integrate the existing economizer’s floating control signals, but it must also monitor those signals for a re-indexing operation and schedule a matching pre-programmed maneuver so that the existing damper actuator performs that action, even if the EBC mode output doesn’t match the existing economizer output at all.

The logic of FIG. 9 buries these details to conceptually show that when floating control devices are being used there is a pre-processing step to convert the two floating control signals into the single percentage signal (blocks 901 and 902). After the EBC calculates the desired output (as part of processing the mode - block 903) block 904 executes a post-processing step to convert the single percentage signal back into two floating control signals. Then in block 905, the floating controller signals are sent to the existing damper actuator. Using this technique, the only user-supplied data needed for these operations is the fully closed to open travel time of the actuator.

The pre-processing logic of block 902 is the easiest of the two. In one EBC example, the microcontroller counts up the time the input floating control “Open” signal is active and counts down the time the “Close” input signal is active, a simple integration of the two signals. This count value is then divided by the travel time of the actuator and the percentage of opening is the result. Because the re-indexing maneuvers must exceed the maximum travel time to be sure the actuator is fully closed or open, a constraint function is used to keep the percentage between 0% and 100%.

The post-processing logic of block 904 is only slightly more complex as the microcontroller must keep track of what percentage it calculates itself to be at and use that to determine which, if any, output floating control “Open” or “Close” signals must be activated to achieve the desired output position. The process is similar to the counting, dividing, and constraining in the pre-processor logic of block 902.

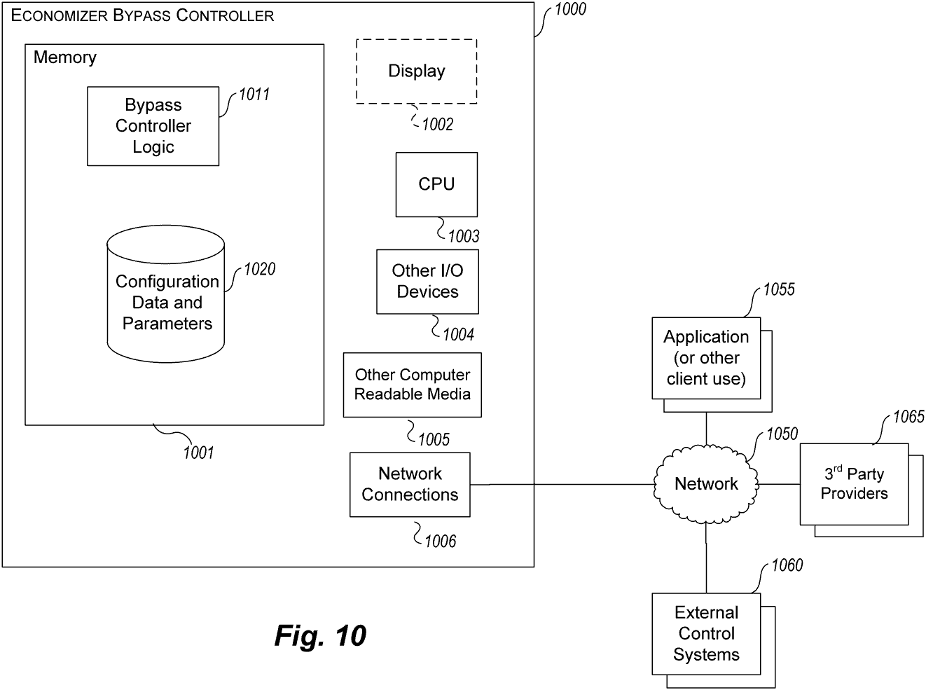

FIG. 10 an example block diagram of an example Economizer Bypass Controller as a computing system used to communicate in a networked environment. It is meant to generally illustrate how a microprocessor controlled EBC can interact with other environments and devices. It is to be understood, as described above, that not all implementations of an EBC contain a microprocessor or the other components described here.

Note that one or more general purpose virtual or physical computing systems suitably instructed or a special purpose computing system may be used to implement an EBC. Further, the EBC may be implemented in software, hardware, firmware, or in some combination to achieve the capabilities described herein.

Note that one or more general purpose or special purpose computing systems/devices may be used to implement the described techniques. However, just because it is possible to implement the EBC techniques on or using a general purpose computing system does not mean that the techniques themselves or the operations required to implement the techniques are conventional or well known.

The economizer bypass controller 1000 may comprise one or more server and/or client computing systems and may span distributed locations. In addition, each block shown may represent one or more such blocks as appropriate to a specific embodiment or may be combined with other blocks. Moreover, the various blocks of the Economizer Bypass Controller 1010 may physically reside on one or more machines, which use standard (e.g., TCP/IP) or proprietary interprocess communication mechanisms to communicate with each other.

In the embodiment shown, economizer bypass controller 1000 comprises a computer memory (“memory”) 1001,, one or more Central Processing Units (“CPU”) 1003, Input/Output devices 1004 (e.g., keyboard, mouse, CRT or LCD display, etc.), other computer-readable media 1005, and one or more network connections 1006. In some embodiments, the EBC is headless - in others display 1002 is present. The EBC 1000 is shown residing in memory 1001.

In other embodiments, some portion of the contents, some of, or all of the components of the EBC 1000 may be stored on and/or transmitted over the other computer-readable media 1005. The components of the EBC 1000 preferably execute on one or more CPUs 1003 and manage the bypass control of a damper unit in an HVAC rooftop unit, as described herein. Of note, one or more of the components in FIG. 10 may not be present in any specific implementation. For example, some embodiments embedded in other software may not provide means for user input or display.

In a typical embodiment, the EBC 1000 includes one or more bypass controller logic modules 1011, and one or more configuration data and parameter data repositories 1020 (which may also include logging information). In at least some embodiments, some portions are all of repository 1020 are provided external to the EBC and are available, potentially, over one or more networks 1050. Other and /or different modules may be implemented. In addition, the EBC may interact via a network 1050 with application or client code 1055 that uses output results computed by the bypass controller logic 1011, one or more external control systems 1060, and/or one or more third-party information provider systems 1065, such as other types of input relating to weather forecasts, emergencies, and the like.

In an example embodiment, components/modules of the EBC 1000 such as logic 1020 are implemented using standard programming techniques. For example, the logic 1020 may be implemented as a “native” executable running on the CPU 1003, along with one or more static or dynamic libraries. In other embodiments, the logic 1020 may be implemented as instructions processed by a virtual machine. A range of programming languages known in the art may be employed for implementing such example embodiments, including representative implementations of various programming language paradigms, including but not limited to, object-oriented, functional, procedural, scripting, declarative, and component-oriented.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the EBC 1000 (e.g., in the data repository 1020) can be available by standard mechanisms such as through C, C++, C#, and Java APIs; libraries for accessing files, databases, or other data repositories; through scripting languages such as XML; or through Web servers, FTP servers, or other types of servers providing access to stored data. The data repository may be implemented as one or more database systems, file systems, or any other technique for storing such information, or any combination of the above, including implementations using distributed computing techniques.

Also the example EBC 1000 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an EBC.

Furthermore, in some embodiments, some or all of the components of the EBC 1000 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computing system configurations.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Pat. Application No. <63/174,528, entitled “AUTOMATED BYPASS CONTROLLER FOR HEATING, VENTILATION, AND COOLING SYSTEMS,” filed Apr. 13, 2021, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing bypass ventilation modes discussed herein are applicable to other architectures. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A controller device for bypassing signals determined by a preexisting economizer controller to transparently control a preexisting damper actuator of an HVAC damper unit, comprising:
a processor;
logic configured, when executed on the processor, to intercept an output signal from the preexisting economizer controller to set an input value for forwarding to the preexisting damper actuator to automatically control damper levels in a manner that defeats default behavior of the preexisting economizer controller by performing:
receiving one or more input values from the preexisting economizer controller;
determining when a bypass mode or an override condition is warranted;
when it is determined that the bypass mode or the override condition is warranted, entering a bypass mode or an override condition to override settings of the preexisting economizer controller, wherein the bypass mode and the override condition control damper louvers of the HVAC damper unit based upon a plurality of configured parameters to force a full open position, a full closed position, or a percentage open or closed position of the damper louvers regardless of the economizer output, without human intervention; and
when it is determined that the bypass mode or the override condition is not warranted, causing the damper louvers to be controlled by the preexisting economizer controller;
wherein the controller device is positioned between the preexisting economizer controller to and the preexisting damper actuator in an already installed HVAC unit.

2. The device of claim 1, wherein the logic is configured to override the settings of the preexisting economizer controller to cause the damper louvers to open when increased ventilation is needed responsive to a determination of a health condition.

3. The device of claim 2 wherein the health condition is prevention of spread of a disease.

4. The device of claim 1, wherein the logic is configured to override the settings of the preexisting economizer controller to cause the damper louvers to close when decreased ventilation is needed responsive to a determination of a health condition.

5. The device of claim 4 wherein the health condition is prevention of spread of smoke.

6. The device of claim 1 wherein the percentage open or closed position is determined by configurable user parameters.

7. The device of claim 1 wherein the logic is further configured to detect an alarm, malfunction, or override condition and to cause the damper louvers to adjust a different position in response to the alarm, malfunction, or override condition.

8. The device of claim 1 wherein the logic is further configured to determine when a bypass mode or an override condition is warranted based upon input from one or more temperature and/or environmental sensors.

9. The device of claim 8 wherein the environmental sensors include one or more sensors for detecting and monitoring CO₂, CO, VOC, SO₂, and NO_{2.}

10. The device of claim 1, wherein the logic is further configured to determine when a bypass mode or an override condition is warranted in response to receiving one or more values from a remote control device.

11. A method in a bypass controller device for controlling louvers of an existing damper unit, the bypass controller device located between an existing economizer controller and an existing damper actuator and configured to automatically control damper levels in a manner that defeats default behavior of the existing economizer controller, comprising:
receiving one or more input values from the existing economizer controller;
determining when a bypass mode or an override condition is warranted;
when it is determined that the bypass mode or override condition is warranted, entering a bypass mode or an override condition to override settings of the existing economizer controller, wherein the bypass mode and the override condition controls damper louvers of the HVAC damper unit based upon a plurality of configured parameters to force a full open position, a full closed position, or a percentage open or closed position of the damper louvers regardless of the economizer output, without human intervention; and
when it is determined that the bypass mode or override condition is not warranted, causing the damper louvers to be controlled by the existing economizer controller.

12. The method of claim 11, further comprising overriding the existing economizer controller to automatically cause the damper louvers to open when increased ventilation is needed responsive to a determination of a health condition.

13. The method of claim 11, further comprising overriding the existing economizer controller to automatically cause the damper louvers to close when decreased ventilation is needed responsive to a determination of a health condition.

14. The method of claim 11 wherein the determining when a bypass mode or an override condition is warranted further comprises detecting an alarm, malfunction, or override condition, the method further comprising:
causing the damper louvers to adjust a different position in response to the detected alarm, malfunction, or override condition.

15. The method of claim 11 wherein the determining when a bypass mode or an override condition is warranted further comprises receiving input from one or more temperature and/or environmental sensors.

16. A computer-readable memory medium containing instructions for controlling a computer processor, when executed, to control louvers of an existing damper unit to bypass signals of an existing economizer controller by performing a method comprising:
receiving one or more input values from the existing economizer controller;
determining when a bypass mode or an override condition is warranted;
when it is determined that the bypass mode or override condition is warranted, entering a bypass mode or an override condition to override settings of the existing economizer controller, wherein the bypass mode and the override condition controls damper louvers of the HVAC damper unit based upon a plurality of configured parameters to force a full open position, a full closed position, or a percentage open or closed position of the damper louvers regardless of the economizer output, without human intervention; and
when it is determined that the bypass mode or override condition is not warranted, causing the damper louvers to be controlled by the existing economizer controller.

17. The computer-readable memory medium of claim 16, further comprising instructions for controlling a computer processor, when executed, to override the existing economizer controller to cause the damper louvers to open when increased ventilation is needed responsive to a determination of a health condition.

18. The computer-readable memory medium of claim 16, further comprising instructions for controlling a computer processor, when executed, to override the existing economizer controller to cause the damper louvers to close when decreased ventilation is needed responsive to a determination of a health condition.

19. The computer-readable memory medium of claim 16, further comprising instructions for controlling a computer processor, when executed, to detect an alarm, malfunction, or override condition and causing the damper louvers to adjust a different position in response to the alarm, malfunction, or override condition.

20. The method of claim 16 further comprising instructions for controlling a computer processor, when executed, to determine when a bypass mode or an override condition is warranted by receiving input from one or more temperature and/or environmental sensors.
